(19) United States
(12) Patent Application Publication
(10) Pub. No.: US 2013/0153109 A1
(43) Pub. Date: Jun. 20, 2013

(54) TIRE, THE CROWN AREA OF WHICH IS PROVIDED WITH AN INNER LAYER FOR REDUCING RUNNING NOISE

(71) Applicants: Nanae Shimanaka, Kyoto (JP); Mitsue Tanaka, Ota (JP)

(72) Inventors: Nanae Shimanaka, Kyoto (JP); Mitsue Tanaka, Ota (JP)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/699,950

(22) PCT Filed: May 17, 2011
(86) PCT No.: PCT/EP11/57922

§ 371 Date: Feb. 26, 2013

(30) Foreign Application Priority Data
May 27, 2010 (FR) 1054096

(51) Int. Cl. B60C 1/00

(52) U.S. Cl. CPC B60C 1/00
USPC 152/537

(57) ABSTRACT

A radial tyre for reducing rolling noise includes a tread with a contact part located at a radially outer position to make contact with the road, two inextensible beads, two sidewalls connecting the beads to the tread, a carcass reinforcement, a belt arranged circumferentially between the radially outer part of the tread and the carcass reinforcement, and an inner crown layer located at a radially inner position. A formulation of the inner crown layer is different from a formulation of the contact part of the tread, and includes: 50 to 100 phr (parts by weight per hundred parts of elastomer) of a copolymer based on styrene and butadiene with a glass transition temperature of greater than −10° C., a reinforcing filler, and a crosslinking system.

### 1. FIELD OF THE INVENTION

The invention relates to tyres for motor vehicles and also to the rubber compositions that may be used for the manufacture of such tyres.

The invention more particularly relates to the rubber compositions used in the crown of tyres with a radial carcass reinforcement, to reduce the noise emitted by these tyres during rolling.

### 2. PRIOR ART

It is known that the noise emitted by a tyre during rolling originates, inter alia, from the vibrations of its structure following the contact of the tyre with the irregularities of the road, also causing a generation of various acoustic waves. The whole is finally perceived in the form of noise, both inside and outside the vehicle. The amplitude of these various manifestations is dependent on the intrinsic modes of vibration of the tyre, but also on the nature of the surfacing on which the vehicle is travelling. The range of frequencies corresponding to noise generated by tyres extends typically from 20 to 4000 Hz approximately.

As regards the noise perceived inside the vehicle, two modes of sound propagation coexist:
the vibrations are transmitted by the wheel centre, the suspension system and the transmission to finally generate noise in the passenger compartment; this is referred to as solid-route transmission, which is generally dominant for the low frequencies of the spectrum (up to about 400 Hz);
the acoustic waves emitted by the tyre are directly propagated via the aerial route into the vehicle, the vehicle acting as a filter; this is referred to as aerial-route transmission, which is generally dominant in the high frequencies (about 600 Hz and above).

The noise known as “road noise” rather makes reference to the overall level perceived in the vehicle and over a frequency range of up to 2000 Hz. The noise known as “cavity noise” refers to the nuisance caused by the resonance of the inflation cavity of the tyre casing.

As regards the noise emitted outside the vehicle, various interactions between the tyre and the road surfacing and between the tyre and the air are pertinent, and will be a nuisance to people in the vicinity of the vehicle when it is rolling on a road. In this case, several sources of noise are also distinguished, such as the “indentation” noise due to the impact of the unevenness of the road in the area of contact, the “friction” noise essentially generated on leaving the area of contact, the “profile” noise due to the arrangement of the profile elements and to the resonance in the various grooves. The “squeal noise” refers to the shrill squealing noise that tyres may make under the effect of friction of their tread during sliding, in particular during cornering at low speed (for example when driving round a roundabout) on road surfacings that have been made smooth after prolonged use and ageing; the specific range of frequencies concerned corresponds herein to a range of from 2000 to 10 000 Hz approximately.

### 3. BRIEF DESCRIPTION OF THE INVENTION

The Applicants have discovered during their investigations a specific rubber composition which, when incorporated into the inner structure of tyres, has improved sound barrier properties in a frequency range of between 2000 and 4000 Hz, which is therefore capable of contributing towards reducing the noises emitted both inside and outside vehicles during the rolling of their tyres. In addition, this specific composition has the advantage of substantially reducing the higher frequency squeal noises.

Consequently, a first subject of the invention concerns a radial tyre for a motor vehicle, comprising:
a crown comprising a tread provided with at least one radially outer part intended to come into contact with the road;
two inextensible beads, two sidewalls connecting the beads to the tread, a carcass reinforcement passing into the two sidewalls and anchored in the beads;
a crown reinforcement or belt arranged circumferentially between the radially outer part of the tread and the carcass reinforcement;
a radially inner elastomeric layer named “inner crown layer”, whose formulation is different from the formulation of the radially outer part of the tread, this inner crown layer itself being arranged circumferentially between the radially outer part of the tread and the carcass reinforcement,
   and being characterized in that this inner crown layer comprises a rubber composition comprising 50 to 100 phr of a copolymer based on styrene and butadiene with a Tg (glass transition temperature) greater than −10° C., a reinforcing filler and a crosslinking system.

The tyres of the invention are particularly intended to equip passenger type motor vehicles, including 4×4 vehicles (four-wheel drive) and SUV vehicles (Sport Utility Vehicles), two-wheel vehicles (especially motorcycles) such as industrial vehicles chosen in particular from vans and heavy-goods vehicles (i.e., metro, bus, road haulage engines such as lorries, tractors, trailers and off-road vehicles such as agricultural engines or civil engineering engines).

The invention relates to the above tyres both in uncured form (i.e., before curing) and in cured form (i.e., after crosslinking or vulcanization).

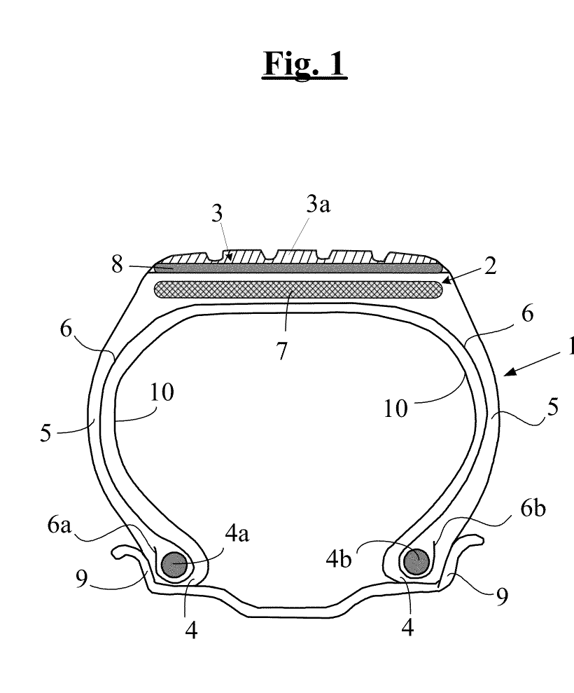

The invention and the advantages thereof will be readily understood in the light of the description and of the implementation examples that follow, and also of FIGS. 1 to 3 relating to these examples, which represent schematically, in radial cross section, examples of radial tyres in accordance with the invention.

### 4. DETAILED DESCRIPTION OF THE INVENTION

In the present description, unless expressly mentioned otherwise, all the percentages (%) indicated are mass percentages.

The term “diene” elastomer (or, without distinction, rubber) means an elastomer at least partly derived (i.e., a homopolymer or a copolymer) from diene monomer(s) (i.e., bearing two conjugated or non-conjugated carbon-carbon double bonds). The term “isoprene elastomer” means an isoprene homopolymer or copolymer, in other words a diene elastomer chosen from the group consisting of natural rubber (NR), synthetic polyisoprenes (IR), various isoprene copolymers and blends of these elastomers.

The abbreviation phr means parts by weight per hundred parts of elastomer or rubber (relative to the total of the elastomers if several elastomers are present).

Moreover, any range of values denoted by the expression “between a and b” represents the range of values extending from more than a to less than b (i.e., limits a and b excluded), whereas any range of values denoted by the expression “from a to b” means the range of values ranging from a up to b (i.e., including the strict limits a and b).

The essential characteristic of the tyre of the invention is thus that it is provided with an inner crown layer comprising a rubber composition that comprises at least 50 to 100 phr of a copolymer based on styrene and butadiene having a glass transition temperature of greater than −10° C., a reinforcing filler and a crosslinking system; these components will be described in detail hereinbelow.

### 4.1—Formulation of the Inner Crown Layer

### A) Copolymer Based on Styrene and Butadiene

The rubber composition forming the protective elastomeric sublayer has the first essential characteristic of comprising 50 to 100 phr of a copolymer based on styrene and butadiene, i.e., a copolymer of at least one styrene monomer and of at least one butadiene monomer; in other words, the said copolymer based on styrene and butadiene comprises by definition at least units derived from styrene and units derived from butadiene. A second essential to characteristic is that its Tg is greater than −10° C., in particular between −10° C. and +30° C.

Preferentially, the content of the said copolymer in the protective elastomeric layer is within a range from 50 to 90 phr and more preferentially in a range from 60 to 85 phr.

Butadiene monomers that are especially suitable for use include 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene. Styrene monomers that are especially suitable for use include styrene, methylstyrenes, para-tert-butylstyrene, methoxystyrenes and chlorostyrenes.

The said copolymer based on styrene and butadiene may have any microstructure that is a function of the polymerization conditions used, especially of the presence or absence of a modifier and/or randomizer and of the amounts of modifier and/or randomizer used. It may be, for example, in block, random, sequenced or microsequenced form, and may be prepared in dispersion or in solution; it may be in couple and/or star form or alternatively functionalized with a coupling and/or star or functionalization agent.

Preferably, the copolymer based on styrene and butadiene is chosen from the group consisting of styrene-butadiene copolymers (abbreviated as SBR), styrene-butadiene-isoprene copolymers (abbreviated as SBIR) and blends of such copolymers.

Among the SBIR copolymers, mention may be made especially of those with a styrene content of between 5% and 50% by weight and more particularly between 10% and 40%, an isoprene content of between 15% and 60% by weight and more particularly between 20% and 50%, a butadiene content of between 5% and 50% by weight and more particularly between 20% and 40%, a content (mol %) of −1,2 units of the butadiene part of between 4% and 85%, a content (mol %) of trans-1,4 units of the butadiene part of between 6% and 80%, a content (mol %) of −1,2 plus −3,4 units of the isoprene part of between 5% and 70% and a content (mol %) of trans-1,4 units of the isoprene part of between 10% and 50%.

More preferentially, an SBR copolymer is used. Among the SBR copolymers, mention may be made especially of those with a styrene content of between 5% and 60% by weight and more particularly between 20% and 50%, a content (mol %) of −1,2 bonds of the butadiene part of between 4% and 75%, and a content (mol %) of trans-1,4 bonds of between 10% and 80%.

Preferably, the Tg of the said copolymer based on styrene and butadiene is greater than 0° C., especially between 0° C. and +30° C. (for example in a range from +5° C. to +25° C.).

The Tg of the elastomers described herein is measured in a conventional manner, which is well known to those skilled in the art, on an elastomer in dry form (i.e., without extension oil) and by DSC (for example according to ASTM D3418-1999).

A person skilled in the art knows how to modify the microstructure of a copolymer based on styrene and butadiene, in particular an SBR, in order to increase and to adjust its Tg, especially by modifying the contents of styrene, of −1,2 bonds or of trans-1,4 bonds of the butadiene part. Use is made more preferentially of an SBR (solution or emulsion) with a styrene content (mol %) which is greater than 35%, and more preferentially between 35% and 60%. SBRs with a high relative Tg are well known to those skilled in the art, and have been used especially in tyre treads to improve some of their wear properties.

The copolymer based on styrene and butadiene above may be combined with at least one second diene elastomer, different from the said copolymer (i.e., not comprising units derived from styrene and from butadiene), the said second diene elastomer being present in a weight content which is consequently not more than 50 phr (as a reminder, phr means parts by weight per one hundred parts of elastomer, i.e., of the total of the elastomers present in the inner crown layer).

This second optional diene elastomer is preferentially chosen from the group consisting of natural rubbers (NR), synthetic polyisoprenes (IR), polybutadienes (BR), isoprene copolymers, and blends of these elastomers. Such copolymers are more preferentially chosen from the group consisting of isoprene-butadiene copolymers (BIR) and isoprene-styrene copolymers (SIR).

Among the latter, the ones that are especially suitable for use are polybutadiene homopolymers (BR) and in particular those with a content (mol %) of −1,2 units of between 4% and 80% or those with a content (mol %) of cis-1,4 of greater than 80%; polyisoprene homopolymers (IR); butadiene-isoprene copolymers (BIR) and especially those with an isoprene content of between 5% and 90% by weight and a Tg of from −40° C. to −80° C.; isoprene-styrene copolymers (SIR) and especially those with a styrene content of between 5% and 50% by weight and a Tg of between −25° C. and −50° C.

According to one preferential embodiment, the second diene elastomer is an isoprene elastomer, more preferentially natural rubber or a synthetic polyisoprene of the cis-1,4 type; among these synthetic polyisoprenes, use is preferably made of polyisoprenes with a content (mol %) of cis-1,4 bonds of greater than 90% and even more preferentially greater than 98%.

More preferentially, the content of second diene elastomer, in particular of isoprene elastomer, especially of natural rubber, is within a range from 10 to 50 phr and even more preferentially within a range from 15 to 40 phr.

The diene elastomers described previously may also be combined, in minor amount, with synthetic elastomers other than diene elastomers, or even polymers other than elastomers, for example thermoplastic polymers.

### B) Reinforcing Filler

The inner crown layer comprises any type of “reinforcing” filler known for its capacities for reinforcing a rubber composition that may be used for the manufacture of tyres, for example an organic filler such as carbon black, an inorganic reinforcing filler such as silica, which is combined, in a known manner, with a coupling agent, or alternatively a mixture of these two types of filler.

Such a reinforcing filler preferentially consists of nanoparticles with a mean (by mass) size of less than one micrometre, generally less than 500 nm, usually between 20 and 200 nm, in particular, and more preferentially between 20 and 150 nm.

Preferentially, the total content of reinforcing filler (in particular of silica or carbon black or a mixture of silica and carbon black) is greater than 20 phr, in particular between 20 and 100 phr. Beyond 100 phr, there is a risk of increasing the hysteresis and thus the resistance to rolling of the tyres. For this reason, the total content of reinforcing filler is more preferentially within a range from 30 to 90 phr.

Carbon blacks that are suitable for use include any carbon black, especially the blacks conventionally used in tyres (known as tyre grade). Among the latter, mention will be made more particularly of the carbon blacks of the series 100, 200, 300, 600 or 700 (ASTM grades), for instance the blacks N115, N134, N234, N326, N330, N339, N347, N375, N550, N683 and N772. The carbon blacks may, for example, be already incorporated into the diene elastomer, especially the isoprene elastomer, in the form of a masterbatch (see, for example, application WO 97/36724 or WO 99/16600).

As examples of organic fillers other than carbon blacks, mention may be made of the functionalized polyvinyl organic fillers as described in applications WO-A-2006/069792, WO-A-2006/069793, WO-A-2008/003434 and WO-A-2008/003435.

The term “reinforcing inorganic filler” should be understood herein as meaning any inorganic or mineral filler, irrespective of its colour and its origin (natural or synthetic), also known as “white” filler or occasionally “clear” filler, as opposed to carbon black, which is capable of reinforcing by itself, without any means other than an intermediate coupling agent, a rubber composition intended for the manufacture of tyres, in other words capable of replacing, in its reinforcing function, a conventional tyre-grade carbon black; such a filler is generally characterized, in a known manner, by the presence of hydroxyl groups (—OH) on its surface.

Reinforcing inorganic fillers that are especially suitable for use include mineral fillers of the siliceous type, preferentially silica (SiO₂). The silica used may be any reinforcing silica known to those skilled in the art, especially any precipitated or fumed silica with a BET surface area and also a CTAB specific surface area both of less than 450 m²/g, preferably from 30 to 400 m²/g, and especially between 60 and 300 m²/g. Examples of highly dispersible precipitated silicas (HDS) that will be mentioned include the silicas Ultrasil 7000 and Ultrasil 7005 from the company Degussa, the silicas Zeosil 1165 MP, 1135 MP and 1115 MP from the company Rhodia, the silica Hi-Sil EZ150G from the company PPG and the silicas Zeopol 8715, 8745 and 8755 from the company Huber.

To couple the reinforcing inorganic filler to the diene elastomer, use is made, in a known manner, of a coupling agent (or bonding agent) that is at least difunctional in order to ensure a sufficient connection, of chemical and/or physical nature, between the inorganic filler (surface of its particles) and the diene elastomer. Use is made in particular of at least difunctional organosilanes or polyorganosiloxanes.

Use is made especially of polysulfide silanes, which are said to be “symmetric” or “asymmetric” according to their particular structure, as described, for example, in applications WO03/002648 (or US 2005/016651) and WO03/002649 (or US 2005/016650).

Silanes that are in particular suitable for use, without the definition below being limiting, include the polysulfide silanes corresponding to the general formula (I) below:

Z-A-Sₓ-A-Z, (I)

in which:
x is an integer from 2 to 8 (preferably from 2 to 5);
the symbols A, which may be identical or different, represent a divalent hydrocarbon-based radical (preferably a C₁-C₁₈ alkylene group or a C₆-C₁₂ arylene group, more particularly a C₁-C₁₀ and especially C₁-C₄ alkylene, in particular propylene);
the symbols Z, which may be identical or different, correspond to one of the three formulae below:

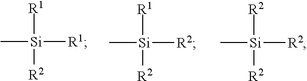

in which:
the radicals R¹, which may be substituted or unsubstituted, and identical or different, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the radicals R², which may be substituted or unsubstituted, and identical or different, represent a C₁-C₁₈ alkoxy or C₅-C₁₈ cycloalkoxy group (preferably a group chosen from C₁-C₈ alkoxy and C₅-C₈ cycloalkoxy, more preferentially still a group chosen from C₁-C₄ alkoxy, in particular methoxy and ethoxy).

In the case of a mixture of polysulfide alkoxysilanes corresponding to formula (I) above, especially common commercially available mixtures, the mean value of “x” is a fractional number preferably between 2 and 5 and more preferentially close to 4. However, the invention may also advantageously be performed, for example, with disulfide alkoxysilanes (x=2).

Examples of polysulfide silanes that will be mentioned more particularly include polysulfides (especially disulfides, trisulfides or tetrasulfides) of bis(alkoxy(C₁-C₄)alkyl(C₁-C₄)silyl(C₁-C₄))alkyl, for instance bis(3-trimethoxysilylpropyl) or bis(3-triethoxysilylpropyl)) polysulfides. Among these compounds, use is made in particular of bis(3-triethoxysilylpropyl) tetrasulfide, abbreviated as TESPT, of formula [(C₂H₅O)₃Si(CH₂)₃S₂]₂ or bis(triethoxysilylpropyl) disulfide, abbreviated as TESPD, of formula [(C₂H₅O)₃Si(CH₂)₃S]₂. Mention will also be made, as preferential examples, of polysulfides (especially disulfides, trisulfides or tetrasulfides) of bis((C₁-C₄)monoalkoxy(C₁-C₄)dialkylsilylpropyl), more preferentially bis-(monoethoxydimethylsilylpropyl) tetrasulfide as described in patent application WO 02/083 782 mentioned previously (or U.S. Pat. No. 7,217,751).

As examples of coupling agents other than an alkoxysilane polysulfide, mention will be made especially of difunctional POS (polyorganosiloxanes) or hydroxysilane polysulfides (R²═OH in formula I above) as described, for example, in patent applications WO 02/30939 (or U.S. Pat. No. 6,774,255), WO 02/31041 (or US 2004/051 210) and WO2007/061 550, or silanes or POSs bearing azodicarbonyl functional groups, as described, for example, in patent applications WO 2006/125 532, WO 2006/125 533 and WO 2006/125 534.

As examples of other silane sulfides, examples that will be mentioned include silanes bearing at least one thiol function (—SH) (known as mercaptosilanes) and/or at least one blocked thiol to function, as described, for example, in patents or patent applications U.S. Pat. No. 6,849,754, WO 99/09036, WO 2006/023 815, WO 2007/098 080.

Needless to say, mixtures of the coupling agents mentioned previously may also be used, as described especially in the abovementioned patent application WO 2006/125 534.

When the inner crown layers are reinforced with an inorganic filler such as silica, the content of coupling agent is preferentially between 2 and 15 phr and more preferentially between 3 and 12 phr.

A person skilled in the art will understand that, as a filler equivalent to the reinforcing inorganic filler described in the present paragraph, a reinforcing filler of another nature may be used, especially of organic nature such as carbon black, as long as this reinforcing filler is covered with an inorganic layer such as silica, or comprises on its surface functional sites, especially hydroxyls, necessitating the use of a coupling agent to establish the bond between the filler and the elastomer. By way of example, mention may be made, for example, of carbon blacks for tyres as described, for example, in patents WO 96/37547 and WO 99/28380.

### C) Crosslinking System

The crosslinking system is preferentially based on sulfur and on a primary vulcanization accelerator, in particular an accelerator of the sulfenamide type. Associated with this vulcanization system, incorporated during the first non-productive phase and/or during the productive phase, are various known secondary accelerators or vulcanization activators such as zinc oxide, stearic acid, guanidine derivatives (in particular diphenylguanidine), etc. The sulfur content is preferably between 0.5 and 5 phr, and the primary accelerator content is preferably between 0.5 and 8 phr.

Use may be made, as accelerator (primary or secondary), of any compound that is capable of acting as a vulcanization accelerator for diene elastomers in the presence of sulfur, especially accelerators of the thiazole type and also derivatives thereof, and accelerators of the thiuram or zinc dithiocarbamate type. These accelerators are more preferentially chosen from the group consisting of 2-mercaptobenzothiazyl disulfide (abbreviated as MBTS), N-cyclohexyl-2-benzothiazyl sulfenamide (abbreviated as CBS), N,N-dicyclohexyl-2-benzothiazyl sulfenamide (DCBS), N-tert-butyl-2-benzothiazyl sulfenamide (TBBS), N-tert-butyl-2-benzothiazyl sulfenimide (TBSI), zinc dibenzyldithiocarbamate (ZBEC), and mixtures of these compounds.

### D) Various Additives

The inner crown layer may also comprise all or some of the usual additives usually used in rubber compositions for tyres, for instance protective agents such as chemical ozone counteractants, antioxidants, plasticizers or extender oils, whether the latter are of aromatic or non-aromatic nature, especially very sparingly aromatic or non-aromatic oils, for example of the naphthenic or paraffinic type, of high or, preferably, low viscosity, MES or TDAE oils, high-Tg hydrocarbon-based plasticizing resins, processability agents for the compositions in the raw state, tackifying resins, reinforcing resins (such as resorcinol or bismaleimide), methylene acceptors or donors, for instance hexamethylenetetramine or hexamethoxymethylmelamine.

In particular, it turned out that hydrocarbon-based plasticizing resins with a high Tg, preferably greater than 20° C. and more preferentially greater than 30° C. (measured according to ASTM D3418-1999), may advantageously be used since they may make it possible to further improve the “sound barrier” technical effect afforded by the inner crown layer described previously.

The hydrocarbon-based resins (it is recalled that the term “resin” is reserved by definition for a compound that is solid at 23° C.) are polymers that are well known to those skilled in the art, which may be used in particular as plasticizers or tackifying agents in polymer matrices. They have been described, for example, in the book entitled “Hydrocarbon Resins” by R. Mildenberg, M. Zander and G. Collin (New York, VCH, 1997, ISBN 3-527-28617-9), chapter 5 of which is devoted to their applications, especially in tyre rubbers (5.5. “Rubber Tires and Mechanical Goods”). They may be aliphatic, aromatic, of the aliphatic/aromatic type, i.e., based on aliphatic and/or aromatic, hydrogenated or non-hydrogenated monomers. They may be natural or synthetic, optionally based on petroleum (if such is the case, they are also known under the name “petroleum resins”). They are preferentially exclusively hydrocarbon-based, i.e., they comprise only carbon and hydrogen atoms.

Preferably, their number-average molecular mass (Mn) is between 400 and 2000 g/mol and especially between 500 and 1500 g/mol; their polydispersity index (Ip) is preferentially less than 3 and especially less than 2 (reminder: Ip=Mw/Mn with Mw being the weight-average molecular mass). The macrostructure (Mw, Mn and Ip) of the hydrocarbon-based resin is determined by steric exclusion chromatography (SEC): tetrahydrofuran solvent; temperature 35° C.; concentration 1 g/l; flow rate 1 ml/min; solution filtered through a filter of porosity 0.45 μm before injection; Moore calibration with polystyrene standards; set of 3 Waters columns in series (Styragel HR4E, HR1 and HR0.5); detection by differential refractometry (Waters 2410) and its associated exploitation software (Waters Empower).

As examples of the above hydrocarbon-based plasticizing resins, mention will be made especially of cyclopentadiene or dicyclopentadiene homopolymer or copolymer resins, terpene (e.g., α-pinene, β-pinene, dipentene or polylimonene) homopolymer or copolymer resins, C5 fraction or C9 fraction homopolymer or copolymer resins, for example C5 fraction/styrene copolymer resin or C5 fraction/C9 fraction copolymer resin.

The content of hydrocarbon-based resin is preferentially between 5 and 60 phr, especially between 5 and 50 phr and even more preferentially in a range from 10 to 40 phr.

The inner crown layers may also contain coupling activators when a coupling agent is used, agents for covering the inorganic filler when an inorganic filler is used, or, more generally, processing agents that may, in a known manner, by means of improving the dispersion of the filler in the rubber matrix and lowering the viscosity of the compositions, improve their processability in the raw state; these agents are, for example, hydroxysilanes or hydrolysable silanes such as alkylalkoxysilanes, polyols, polyethers, amines, and hyroxylated or hydrolysable polyorganosiloxanes.

### E) Manufacture of the Compositions

The rubber compositions forming the inner crown layer are manufactured in appropriate mixers using, for example, two successive preparation phases according to a general procedure that is well known to those skilled in the art: a first phase of thermomechanical working or kneading (occasionally termed the “non-productive” phase) at high temperature, up to a maximum temperature of between 130° C. and 200° C. and preferably between 145° C. and 185° C., followed by a second phase of mechanical work (occasionally termed the “productive” phase) at lower temperature, typically less than 120° C., for example between 60° C. and 100° C., during which finishing phase the crosslinking or vulcanization system is incorporated.

A process that may be used for the manufacture of such rubber compositions comprises, for example and preferably, the following steps:
incorporating into a mixer 50 to 100 phr of the copolymer based on styrene and butadiene and the reinforcing filler, and thermomechanically kneading the whole, one or more times, until a maximum temperature of between 130° C. and 200° C. is reached;
cooling the whole to a temperature below 100° C.;
next, incorporating a crosslinking system;
kneading the whole up to a maximum temperature of less than 120° C.;
extruding or calendering the rubber composition thus obtained.

By way of example, the first phase (non-productive) is performed in a single thermomechanical step during which all the necessary constituents, the optional covering agents or additional processing agents and other various additives, with the exception of the crosslinking system, are introduced into an appropriate mixer such as a common internal mixer. After cooling the mixture thus obtained in the course of the first non-productive phase, the crosslinking system is then incorporated at low temperature, generally in an external mixer such as a roll mixer; the whole is then mixed (productive phase) for a few minutes, for example between 5 and 15 minutes.

The final composition thus obtained is then calendered, for example in the form of a sheet or a plate, especially for characterization in the laboratory, or alternatively extruded in the form of a rubber profiled element which may be used directly as inner crown layer, for example as the “base” part of a tread of “cap-base” structure, or alternatively as the calendering crown ply of textile or metallic reinforcements.

The vulcanization (or curing) is conducted in a known manner at a temperature generally of between 130° C. and 200° C., for a sufficient time that may range, for example, between 5 and 90 minutes as a function especially of the curing temperature, of the vulcanization system adopted and of the vulcanization kinetics of the composition under consideration.

Preferably, the inner crown layer has, in the vulcanized state (i.e., after curing), a secant modulus in extension E10 which is less than 30 MPa, more preferentially between 2 and 25 MPa and in particular between 5 and 20 MPa. The “secant modulus in extension” (denoted E10) is the tensile modulus measured in second elongation (i.e., after an accommodation cycle) at 10% elongation (according to ASTM D412 1998; specimen “C”), this modulus being the “true” secant modulus, i.e., reduced to the real cross section of the specimen (normal temperature and hygrometry conditions according to standard ASTM D1349-1999).

### 5. EXAMPLES OF IMPLEMENTATION OF THE INVENTION

The rubber composition described previously is thus used, in the tyre of the invention, as an inner crown layer arranged circumferentially inside the crown of the tyre, between, on the one side, the radially outermost part of its tread, i.e., the portion intended to come into contact with the road during rolling, and, on the other hand, the carcass reinforcement. The term “inner” crown layer means any rubber part of the tyre crown that is not exposed to the outside of the tyre outer casing, which is not in contact with the air or an inflation gas, in other words which is thus located to the very interior of the inner structure of the tyre crown.

It should thus be understood that this inner crown layer may be arranged, for example:
in the tread itself, but, in this case, under the portion (i.e., radially internally relative to this portion) of tread which is intended to come into contact with the road during the rolling of the tyre, throughout the lifetime of the tyre;
under the tread (i.e., radially internally relative to this tread), between the tread and the belt;
between the belt and the carcass reinforcement of the tyre;
of alternatively it may constitute all or part of the rubber matrices coating the textile and/or metallic reinforcements present in the belt itself of the tyre, for example as a coating or calendering rubber for the hooping crown plies, protective crown plies or working crown plies constituting the said belt.

The thickness of this protective elastomeric layer is preferably between 0.1 and 2 mm, especially in a range from 0.2 to 1.5 mm.

The attached FIGS. 1 to 3 show in radial cross section, in a very schematic manner (especially without being to a specific scale), three preferential examples of motor vehicle tyre outer casings with radial carcass reinforcement, in accordance with the invention.

FIG. 1 illustrates a first possible embodiment of the invention, according to which the inner crown layer (8) is integrated into the tread (3) itself, but arranged under the portion (3a) of the tread that is intended to come into contact with the road during rolling, to constitute what is customarily known as a tread sublayer. It may also be recalled that, in such a case, the tread is also commonly referred to by those skilled in the art as a tread with “cap-base” structure, the term “cap” denoting the profiled portion of the tread intended to come into contact with the road and the term “base” denoting the non-profiled portion of the tread, of different formulation, which, itself, is not intended to come into contact with the road.

In this FIG. 1, the tyre outer casing (1) represented schematically comprises a crown (2) comprising a tread (3) (to simplify, comprising a very simple profile) whose radially outer part (3a) is intended to come into contact with the road, two inextensible beads (4) in which is anchored a carcass reinforcement (6). The crown (2), connected to the said beads (4) via two sidewalls (5) is, in a known manner, reinforced with a crown reinforcement or “belt” (7) that is at least partly metallic and radially outer relative to the carcass reinforcement (6).

More specifically, a tyre belt generally consists of at least two superposed belt plies, occasionally referred to as “working” plies or “crossed” plies, whose reinforcement elements or “reinforcements” are arranged virtually parallel to each other inside a ply, but crossed from one ply to another, i.e., inclined, symmetrically or non-symmetrically, relative to the median circumferential plane, by an angle that is generally between 10° and 45° depending on the type of tyre under consideration. Each of these two crossed plies consists of a rubber matrix or “calendering rubber” coating the reinforcements. In the belt, the crossed plies may be completed by various other auxiliary plies or layers of rubber, of variable widths depending on the case, optionally comprising reinforcements; mention will be made, by way of example, of simple rubber cushions, of “protective” plies responsible for protecting the rest of the belt against external attack, perforations, or alternatively “hooping” plies comprising reinforcements oriented substantially along the circumferential direction (“zero-degree” plies), whether they are radially outer or inner relative to the crossed plies.

For the reinforcement of the above belts, in particular of their crossed plies, protective plies or hooping plies, reinforcements in the form of steel cords or textile cords consisting of thin wires assembled together by cabling or plying, are generally used.

The carcass reinforcement (6) is anchored here in each bead (4) by winding around two bead wires (4a, 4b), the turn-up (6a, 6b) of this reinforcement (6) being arranged, for example, towards the outside of the tyre (1), which is shown here mounted on its rim (9). The carcass reinforcement (6) consists of at least one ply reinforced with radial textile cords, i.e., these cords are arranged virtually parallel to each other and extend from one bead to the other so as to form an angle of between 80° and 90° with the median circumferential plane (plane perpendicular to the axis of rotation of the tyre which is located at mid-distance between the two beads (4) and passes through the middle of the crown reinforcement (7)). Needless to say, this tyre (1) also comprises, in a known manner, an inner rubber or elastomer layer (10) (commonly known as an “inner rubber” or “inner liner”) which defines the radially inner face of the tyre and which is intended to protect the carcass ply against the diffusion of air originating from the inner space of the tyre.

This example of a tyre (1) in accordance with the invention of FIG. 1 is characterized in that the base part (8) of its tread (3) consists of the inner crown layer that has been described in detail previously.

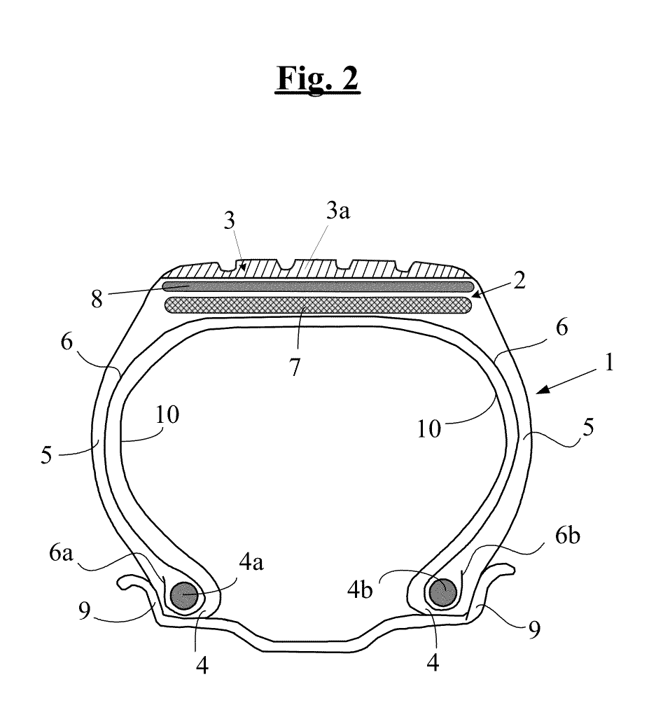

FIG. 2 illustrates another possible embodiment of the invention, according to which the inner crown layer (8) is outside the tread (i.e., distinct therefrom), arranged this time, still in the crown (2), below the tread (i.e., radially internally relative to the tread) and above the belt (i.e., radially externally relative to the belt), in other words between the tread (3) and the belt (7).

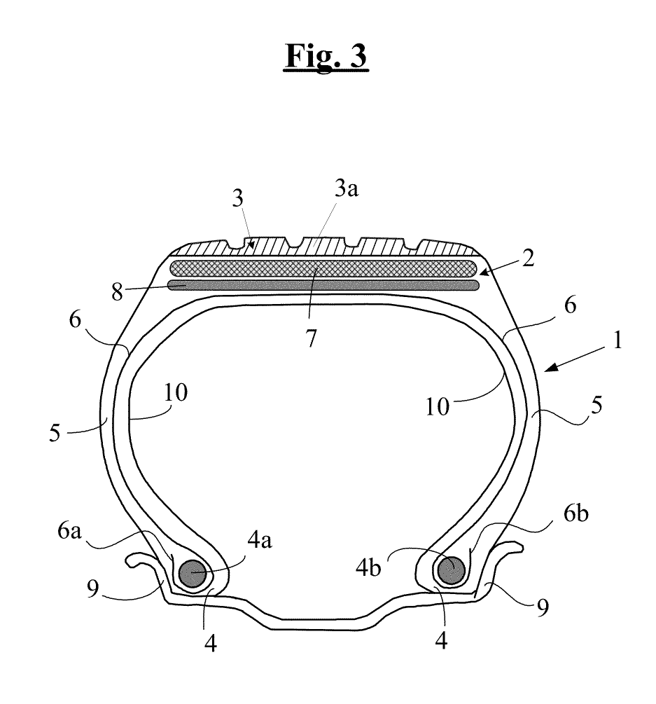

FIG. 3 illustrates another possible embodiment of the invention, according to which the inner crown layer described previously is arranged between the belt (7) and the carcass reinforcement (6) of the tyre.

In all these cases represented schematically by the figures commented above, the inner crown layer, by virtue of its improved sound-barrier properties, is capable of contributing towards reducing the noises emitted both inside and outside vehicles during the rolling of their tyres; in particular, it can appreciably reduce the squealing noises emitted by tyres, as demonstrated in the tests that follow.

For the needs of these tests, a rubber composition (denoted C-1 below) was prepared, the formulation of which is given in the attached table, the contents of the various products being expressed in phr (parts by weight per hundred parts of elastomer, consisting here of SBR and NR).

For the manufacture of this composition, the process was performed in the following manner: the reinforcing filler (carbon black), the diene elastomer (SBR and NR) and also the various other ingredients with the exception of the vulcanization system, were successively introduced into an internal mixer, whose initial tank temperature was about 60° C.; the mixer was thus filled to about 70% (% by volume). Thermomechanical work (non-productive phase) was then performed in a step of about 2 to 4 minutes, until a maximum “dropping” temperature of 165° C. was reached. The mixture thus obtained was recovered, cooled and sulfur and a sulfenamide type accelerator were then incorporated therein on an external mixer (homo-finisher) at 30° C., by mixing the whole (productive phase) for a few minutes.

The composition thus obtained was then calendered in the form of a sublayer (8) or base (thickness 2 mm) of a tread of the cap-base type, and this tread was then incorporated into the structure of passenger vehicle tyres (dimensions 225/55 R16) as illustrated in FIG. 1, the tread of which, for its radially outer part (3a), consisting of a conventional rubber composition for a “green tyre” with a low rolling resistance, comprising an SBR/BR blend as diene elastomer and silica as reinforcing filler.

These tyres (denoted P-1) in accordance with the invention were compared with control tyres (denoted P-2) of identical dimensions and construction, provided with the same tread of conventional formulation as that described above, but whose crown area did not have the sublayer (8) as inner crown layer.

To characterize the two tyres and the sound-barrier properties afforded by the inner crown layer added to the tyre in accordance with the invention, a rolling test was performed under real conditions (Toyota Celsior model vehicle) during which the driver establishes a subjective note of his perception of the squealing noise inside the vehicle during a series of corners taken at low speed (5 to 15 km/h) on a surface of smooth type.

For a notation scale ranging from 0 (no noise perceived under the test conditions) to 5 (maximum noise), an average reduction of about 2 points was observed, which is entirely significant to a person skilled in the art.

The road test measurements of rolling resistance (method ISO 87-67/1992) moreover revealed identical values on the two types of tyre (P-1 and P-2) which demonstrates that the incorporation of the inner crown layer does not penalize the hysteresis thereof.

In conclusion, the incorporation into the structure of a tyre of the inner crown layer according to the invention, based on a copolymer based on styrene and butadiene having a very high glass transition temperature (greater than −10° C.), makes it possible to substantially reduce the squeal noises of tyres perceived both inside and outside the vehicles, without penalizing the rolling resistance of these tyres.

TABLE

| Formulation: | phr |
|---|---|
| SBR (1) | 80 |
| NR (2) | 20 |
| carbon black (3) | 50 |
| aromatic oil | 40 |
| ZnO | 2.5 |
| stearic acid | 0.5 |
| antioxidant (4) | 2 |
| sulphur | 5 |
| accelerator (5) | 2 |

(1) SBR solution comprising 50% of styrene units and 50% of butadiene units (Tg = +10° C.); for the butadiene part, 60% of 1-2 units, 40% of 1-4 units;
(2) natural rubber (peptized);
(3) ASTM N326 grade (Cabot company);
(4) N-1,3-dimethylbutyl-N-phenyl-para-phenylenediamine (Santoflex 6-PPD from the company Flexsys);
(5) N-dicyclohexyl-2-benzothiazole-sulfenamide (Santocure CBS from the company Flexsys).

1-17. (canceled)

18. A radial tyre for a motor vehicle, comprising:
a crown that includes a tread provided with a part located at a radially outer position, the part being intended to come into contact with a road surface;
two inextensible beads;
two sidewalls connecting the two inextensible beads to the tread;
a carcass reinforcement passing into the two sidewalls and anchored in the two inextensible beads;
a belt arranged circumferentially between the part of the tread located at the radially outer position and the carcass reinforcement; and
an inner crown layer located at a radially inner position, the inner crown layer being formed of an elastomeric material having a formulation that is different from a formulation of the part of the tread located at the radially outer position, and the inner crown layer being arranged circumferentially between the part of the tread located at the radially outer position and the carcass reinforcement,
wherein the inner crown layer is formed of at least a rubber composition that includes 50 to 100 phr of a copolymer based on styrene and butadiene with a glass transition temperature of greater than −10° C., a reinforcing filler, and a crosslinking system.

19. The tyre according to claim 18, wherein the copolymer based on styrene and butadiene is chosen from a group that includes: styrene-butadiene copolymers, styrene-butadiene-isoprene copolymers, and blends thereof.

20. The tyre according to claim 19, wherein the copolymer based on styrene and butadiene is a styrene-butadiene copolymer.

21. The tyre according to claim 18, wherein the copolymer based on styrene and butadiene has a glass transition temperature of greater than 0° C.

22. The tyre according to claim 18, wherein the copolymer based on styrene and butadiene is used as a mixture with not more than 50 phr of a second diene elastomer that is different from the copolymer based on styrene and butadiene.

23. The tyre according to claim 22, wherein the second diene elastomer is chosen from a group that includes: natural rubbers, synthetic polyisoprenes, polybutadienes and isoprene copolymers, and blends thereof.

24. The tyre according to claim 23, wherein the second diene elastomer is an isoprene copolymer.

25. The tyre according to claim 23, wherein the second diene elastomer is a natural rubber.

26. The tyre according to claim 18, wherein a content of the copolymer based on styrene and butadiene in the rubber composition of the inner crown layer is within a range from 50 to 90 phr.

27. The tyre according to claim 22, wherein a content of the second diene elastomer in the rubber composition of the inner crown layer is within a range from 10 to 50 phr.

28. The tyre according to claim 18, wherein a content of the reinforcing filler in the rubber composition of the inner crown layer is greater than 20 phr.

29. The tyre according to claim 18, wherein a content of reinforcing filler is within a range from 30 to 90 phr.

30. The tyre according to claim 18, wherein the reinforcing filler includes silica, or carbon black, or a mixture of silica and carbon black.

31. The tyre according to claim 18, wherein the rubber composition of the inner crown layer includes a hydrocarbon-based plasticizing resin.

32. The tyre according to claim 18, wherein the inner crown layer has a thickness of between 0.1 and 2 mm.

33. The tyre according to claim 18, wherein the inner crown layer has a thickness of between 0.2 to 1.5 mm.

34. The tyre according to claim 18, wherein the tread has a cap-base structure, and the inner crown layer constitutes a base of the cap-base structure.

35. The tyre according to claim 18, wherein the inner crown layer constitutes a belt ply reinforced with a plurality of at least one of textile reinforcements and metallic reinforcements coated by the rubber composition of the inner crown layer.
